(19) United States
(12) Patent Application Publication
(10) Pub. No.: US 2016/0289105 A1
(43) Pub. Date: Oct. 6, 2016

(54) OILFIELD WATER STORAGE SYSTEMS, METHODS OF MANAGING THE SAME, AND FILM-FORMING COMPOSITIONS

(71) Applicants: TIMOTHY AL ANDRZEJAK, Sugar Land, TX (US); JORGE E. LOPEZ DE CARDENAS, Sugar Land, TX (US)

(72) Inventors: TIMOTHY AL ANDRZEJAK, Sugar Land, TX (US); JORGE E. LOPEZ DE CARDENAS, Sugar Land, TX (US)

(21) Appl. No.: 15/089,441

(22) Filed: Apr. 1, 2016

Related U.S. Application Data
(60) Provisional application No. 62/142,474, filed on Apr. 3, 2015.

(51) Int. Cl. C02F 1/68; E21B 43/26; E21B 41/00

(52) U.S. Cl. CPC C02F 1/68; E21B 41/00; E21B 43/26; C02F 2101/30

(57) ABSTRACT

Oilfield water storage systems, methods of managing the same, and film forming compositions are provided herein. In an embodiment, an oilfield water storage system includes a water storage pond, a surface spreading layer on a surface of the water storage pond, and a water outlet pipe disposed in fluid communication with the water storage pond below the surface treatment layer. The surface spreading layer includes a surface spreading agent.

### CROSS-REFERENCE TO RELATED APPLICATIONS

This application claims the benefit of U.S. Provisional Application No. 62/142,474, filed Apr. 3, 2015.

### TECHNICAL FIELD

The technical field generally relates to oilfield water storage systems, methods of managing the same, and film-forming compositions. More particularly, the technical field relates to oilfield water storage systems including water storage ponds, methods of managing the water storage ponds, and film-forming compositions that may be employed in the management of the water storage ponds.

### BACKGROUND

Oilfield sites regularly employ the use of open-air ponds for storage of water to be used during certain oilfield extraction operations, such as well stimulation, water injection, and hydraulic fracture. Hydraulic fracturing generally involves pumping a fluid into a well at high pressures to create hydraulic fractures in an oil/gas reservoir into which the well is drilled. The fluid used in hydraulic fracturing is generally a mixture of water (−90%), a granular proppant material (−9.5%), and gellants and other common chemicals (−0.5%). The fluid is pumped into a reservoir at high pressures to create hydraulic fractures. The granular proppant material is deposited within the fractures to hold them open, leaving a high porosity flow path for petroleum extraction.

The fluid employed in hydraulic fracturing and the other oilfield extraction operations is subject to various unique management concerns. In particular, excessive biological species content of the water (e.g., the excessive presence of bacterial species, algae, and the like), also referred to as biological contamination, may affect the productivity of the well. In particular, the deposition of bacterial species within the reservoir during hydraulic fracturing operations can lead to declining well productivity. Subsequent growth of the bacterial species reduces permeability and porosity of the reservoir and hydraulic fractures and impedes flow of petroleum through the fractures, thus reducing yield from the well. The process whereby well productivity declines owing to the presence of biological species within hydraulic fractures is also referred to as biofouling.

The remedial actions and full cost related to biofouling in open-air ponds used in hydraulic fracturing are known to be significant. Efforts presently in place to minimize biological species growth to acceptable levels in open-air ponds used for hydraulic fracturing and the other oilfield extraction operations include use of biocides. The biocides decrease the growth of the biological species in the water that can cause clogging of the hydraulic fractures. Treatment of the water with biocides is generally accomplished in-line as the water is being pumped from the pond during a given hydraulic fracturing operation. In-line treatment of the water reduces costs as compared to continuously treating the entirety of the pond during pre-operation storage. As a result, there typically is a lack of control of storage pond health with regard to biological contaminants.

While use of water storage tanks has been considered to isolate the water from sunlight and environmental oxygen, which can lead to bacterial proliferation, some bacterial species are able to thrive in anaerobic environments. Some of the bacteria that thrive in anaerobic environments generate hydrogen sulfide (H₂S), which is undesirable in oilfield applications for various reasons as known in the art. Within the storage tanks, the generated H₂S (which is in gaseous form under ambient temperatures and pressures) may become trapped. Thus, open-air storage ponds, which are also more cost effective than storage tanks, are generally desired as the source of water for the oilfield operations.

Surface spreading agents are known for use in municipal water reservoirs, swimming pools, and agricultural water holding ponds for purposes of trapping heat and/or minimizing evaporation of water. However, municipal water reservoirs, swimming pools, and agricultural water holding ponds are not subject to the same considerations as open-air ponds used at oilfield sites. However, unlike municipal water reservoirs, swimming pools, or agricultural water holding ponds, the water held in the open-air ponds used at oilfield sites is to be pumped into a well and where contamination of the well is a concern. As such, swimming pool and agricultural holding pond solutions are not necessarily appropriate for open-air ponds used at oilfield sites.

Accordingly, it is desirable to provide oilfield water storage systems that employ open-air ponds and methods of managing the same to minimize biological species growth to acceptable levels while possibly minimizing the amount of biocide required to treat the water during hydraulic fracturing operations. It is also desirable to provide systems and methods that enable effective delivery of a surface spreading agent to an open-air water holding pond, and film-forming compositions that include the surface spreading agent. It is also desirable to provide systems and methods for identifying the presence of a surface spreading agent in an open-air water holding pond. Furthermore, other desirable features and characteristics will become apparent from the subsequent detailed description and the appended claims, taken in conjunction with the accompanying drawings and this background.

### BRIEF SUMMARY

Oilfield water storage systems, methods of managing the same, and film forming compositions are provided herein. In an embodiment, an oilfield water storage system includes a water storage pond, a surface spreading layer on a surface of the water storage pond, and a water outlet pipe disposed in fluid communication with the water storage pond below the surface treatment layer. The surface spreading layer includes a surface spreading agent.

In another embodiment, a method of managing an oilfield water storage system is provided. The method includes applying a film-forming composition to a water holding pond of the oilfield water storage system. The film-forming composition includes a surface spreading agent.

In another embodiment, a film-forming composition is provided. The film-forming composition is adapted for application to a water holding pond. The film-forming composition includes a surface spreading agent, a densifying agent, and a dissolution agent. The surface spreading agent is present in an amount of at least 1 weight %, based on the total weight of the film-forming composition. The densifying agent has a higher density than water and the surface spreading agent. The film-forming composition has a higher density than water.

### BRIEF DESCRIPTION OF THE DRAWINGS

The various embodiments will hereinafter be described in conjunction with the following drawing figures, wherein like numerals denote like elements, and wherein:

FIG. 1 is a schematic diagram of an oilfield water storage system in accordance with an embodiment;

FIG. 2 is a schematic diagram illustrating a controller and a dispersing module for the management of a surface spreading agent in accordance with an embodiment; and

FIG. 3 is a schematic diagram illustrating an open-air pond of an oilfield water storage system with the open-air pond having a surface spreading layer formed thereon in accordance with another embodiment.

### DETAILED DESCRIPTION

The following detailed description is merely exemplary in nature and is not intended to limit the oilfield water storage systems and methods of managing the same as described herein. Furthermore, there is no intention to be bound by any theory presented in the preceding background or the following detailed description.

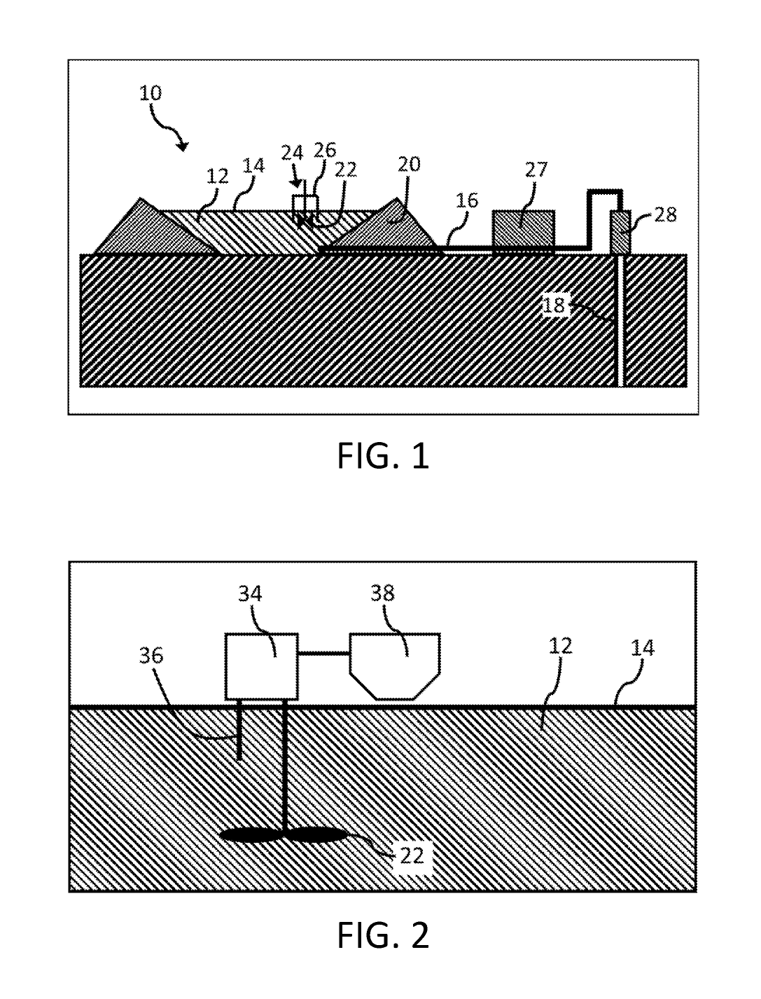

Oilfield water storage systems, methods of managing the oilfield water storage systems, and a film-forming composition are provided herein. Referring to FIGS. 1 and 2, in embodiments the oilfield water storage systems 10 include a water storage pond 12, a surface spreading layer 14 that includes a surface spreading agent with the surface spreading layer 14 disposed on a surface of the water storage pond 12, and a water outlet pipe 16 in fluid communication with the water storage pond 12 below the surface spreading layer 14. The water outlet pipe 16 is also in fluid communication with an oil or gas well 18 to provide water that is ultimately included in fluid used in hydraulic fracturing or other oilfield extraction operations such as well stimulation or water injection. In embodiments, the water storage pond 12 is an open-air pond. As referred to herein, an “open-air” pond is a body of water that is retained in a holding area (which can be earthen, concrete, lined with plastic or clay, or the like) with an upper surface of the body of water open to the ambient environment. In embodiments and as shown in FIG. 1, the water storage pond 12 is raised above the ground with earthen berms 20. In other embodiments and although not shown, large portable tanks are set up akin to giant above-ground pools. In embodiments, the water contained within the water storage pond 12 may be freshwater, produced water, brines, or recycled wastewater. “Produced water” refers to water that is produced from a given well, along with hydrocarbons, that has been subsequently separated. The fluid that is used in the hydraulic fracturing or other oilfield extraction operations and that includes the water from the open-air pond is not particularly limited and can be any fluid that is conventionally employed in oilfield extraction operations. In embodiments, the fluid includes a mixture of water, a granular proppant material, and gellants and other common chemicals.

Without being bound by theory, it is believed that the oilfield water storage systems 10 and methods of managing the oilfield storage systems 10, as described herein, minimize biological species growth by employing the surface spreading agent in the water storage pond. The surface spreading agent forms the surface spreading layer 14 as a film on a surface of the water storage pond 12, with the surface spreading layer 14 being as thin as a single molecule (i.e., a monomolecular layer) in some instances. Without being bound by any particular theory, it is believed that the surface spreading layer 14 on the surface of the water storage pond 12 influences a transfer function related to oxygen dissolution into the water and, thus, is an effective barrier to inhibit dissolution of oxygen from ambient air into the water storage pond 12. As a result, the growth of certain biological species (e.g., aerobic bacterial species, algae, and other biological species that depend upon oxygen to thrive) within the water is inhibited. Furthermore, since the single-molecule thick layer permits a large proportion of sunlight to pass-through, natural solar disinfection of the water is not impeded. Solar disinfection refers to the elimination of bacteria by ultraviolet radiation generated by the sun. Further still, because the water storage pond 12 may be naturally vented due to ambient air currents and agitation, it is believed that any unwanted gas generated by microbes within the water holding pond 12, such as H₂S gas generated by anaerobic microbes, will also be maintained at or below an acceptable level. However, it is to be appreciated that in embodiments and as shown in FIG. 1, a mechanical agitator 22 (i.e., an engineered mechanism adapted to agitate the surface of the water) may be employed to assist with venting of the water storage pond 12. Suitable mechanical agitators 22 include, but are not limited to, those chosen from a water jet, a propeller, or a screw.

In embodiments and referring to FIG. 1, an at least semi-enclosed barrier area 24 is provided using a barrier 26, with the mechanical agitator 22 positioned therein to enable specific designated areas of the water storage pond 12 to be subject to mechanical agitation. By “at least semi-enclosed”, it is meant that the barrier 26 may completely or partially enclose an area on the surface of the water holding pond 12, with the barrier 26 only partially extending down into the water holding pond 12. In this regard, the at least semi-enclosed barrier area 24 may optionally be employed to minimize disturbance of the surface spreading layer 14 on the surface of the water storage pond 12, thereby minimizing unwanted introduction of oxygen into the water storage pond 12 and leaving the surface spreading layer 14 intact over most of the surface of the water holding pond 12 while still effectively venting the water storage pond 12 to minimize build-up of unwanted H₂S within the water holding pond 12.

In embodiments and referring again to FIG. 1, the oilfield water storage system further includes additional conventional components associated with oil or gas well and reservoir usage. For example, a hydraulic fracturing pump 27 may be employed to pressurize water from the water outlet pipe 16, with the pressurized water delivered to a well head 28 and down into the well 18 for purposes of effectuating hydraulic fracturing or other oilfield extraction operations.

The surface spreading agent, as described herein, refers to any combination of compounds that are applied to the water storage pond 12 and that are each capable of forming the surface spreading layer 14 as a film on the surface of the water storage pond 12. In embodiments, the surface spreading agent is delivered in a film-forming composition that may include additional components beyond the surface spreading agent. In other embodiments, the surface spreading agent may be applied directly to the open-air pond in the absence of additional components present with the surface spreading agent.

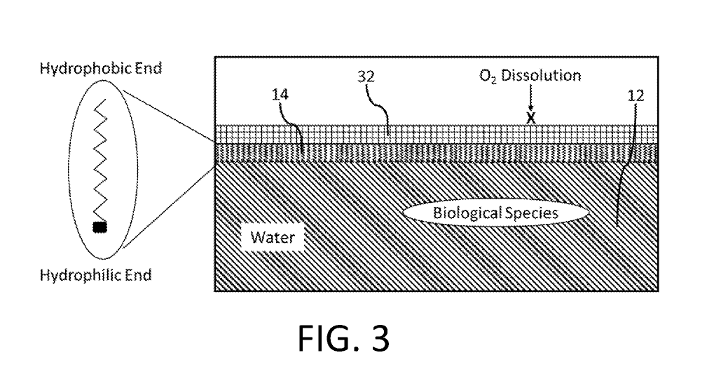

The surface spreading agent can include any compound that exhibits some inhibition of oxygen dissolution in the water storage pond 12 and that is capable of forming a film on the surface of the water storage pond 12. In this regard, the surface spreading agent has a lower density than water, which enables the surface spreading agent to form a surface layer or film. In embodiments, suitable surface spreading agents include those that are capable of generating a monomolecular layer as schematically illustrated in FIG. 3. Examples of suitable surface spreading agents include, but are not limited to, surfactants with optionally unsaturated straight chain molecules that have a hydrophilic portion and a hydrophobic portion. Other suitable surface spreading agents include those that are not generally considered surfactants but that nonetheless exhibit phase separation with water and that are capable of forming the film on the surface of the water storage pond 12. Specific examples of suitable surface spreading agents include, but are not limited to, aliphatic alcohols that contain between 12 and 24 carbon atoms (e.g., 1-dodecanol [C₁₂H₂₆O], 1-hexadecanol [C₁₆H₃₄O], stearyl alcohol [C₁₈H₃₆O], oleyl alcohol [C₁₈H₃₆O], and sorbitan monooleate [C₂₄H₄₄O₆]); polydiorganosiloxanes; polyoxyethylene ether; or a combination thereof.

In embodiments and as alluded to above, the surface spreading agent may be employed in a film-forming composition that includes the surface spreading agent and one or more other components other than the surface spreading agent that provide further functions. For example, in embodiments, additional components may be present to provide additional functionality, such as to assist with delivery of the surface spreading agent in water. In embodiments, the surface spreading agent is present in the film-forming composition in an amount of at least 1 weight %, such as from about 1 to about 20 weight %, or such as from about 5 to about 20 weight %, based on the total weight of the film-forming composition. In one embodiment, the surface spreading agent (especially the aliphatic alcohols) is delivered in solid form and may be combined with a dissolution agent to assist with dispersal of the surface spreading agent in the water holding pond 12. Suitable dissolution agents include, but are not limited to, a salt such as calcium hydroxide, hydrated lime, or the like. In embodiments, the dissolution agent is present in an amount of at least 40 weight %, such as from about 40 to about 95 weight %, or such as from about 80 to about 95 weight %, based on the total weight of the film-forming composition. In addition to or as an alternative to the dissolution agent, the surface spreading agent may be combined with a densifying agent to assist with sub-surface dispersal of the surface spreading agent in the water holding pond 12. The densifying agent has a density that is greater than that of water and that is also greater than that of the surface spreading agent. Examples of suitable densifying agents include, but are not limited to, silica sand, slag sand, pea gravel, metal powders such as iron powder, barite powder, or combinations thereof. In embodiments, the densifying agent is present in the film-forming composition in an amount sufficient to provide the film-forming composition with a density greater than that of water, thereby enabling the sub-surface delivery of the surface spreading agent. For example, in embodiments, the densifying agent is present in an amount of from about 1 to about 50 weight %, such as from about 10 to about 50 weight %, or such as from about 25 to about 50 weight %, based on the total weight of the film-forming composition. In embodiments, the film-forming composition includes a sufficient amount of the densifying agent to render the film-forming composition denser than water, with a balance of the film-forming composition including the dissolution agent and the surface spreading agent. In embodiments in which the surface spreading agent is delivered in solid form, the film-forming composition is substantially free of liquid components, such as solvents. It is to be appreciated that the resulting surface spreading layer 14 may include at least some of the additional components in amounts detectable using conventional diagnostic equipment, even when such components (such as the dissolution agent and densifying agent) are only intended to deliver the surface spreading agent and dissolve into the water or fall to the bottom of the water holding pond 12.

The resulting film-forming composition that includes the surface spreading agent and the additional component(s) may be provided in various forms, such as powdered form, granule form, or tablet form. Powder form, as referred to herein, means a form with D50 particle size of less than about 0.1 mm. Granule form, as referred to herein, means a form with D50 particle size of from about 0.1 mm to about 5 mm. Tablet form, as referred to herein, means a form with a D50 particle size of greater than about 5 mm. In embodiments, the tablets have a minimum dimension through a volume of the tablet of at least 1 cm, such as from about 1 cm to about 50 cm.

The form of the film-forming composition may affect the manner in which the film-forming composition is delivered. For example, when delivered in powder form, the powder may rapidly dissolve in water to release the surface spreading agent. In this embodiment, the powder may be free of the densifying agent. However, when applied to the surface of the water, under certain conditions (e.g. high wind), the powder may migrate to the edge of the water holding pond 12 before it is fully incorporated into the water. Wave action of the water can then deposit the powder along the shoreline. Thus, as an alternative to the powder form, the film-forming composition may be applied in the granule or tablet form, with the film-forming composition including the densifying agent in an amount sufficient to render the film-forming composition denser than water. With the film-forming composition denser than water, the film-forming composition sinks below the surface of the water upon delivery into the water holding pond 12. After the film-forming composition sinks into the water, the film-forming composition rapidly dissolves and releases at least a portion of the surface spreading agent from beneath the water surface, thereby enabling dispersal of the surface spreading agent and minimizing migration of the surface spreading agent under wind or wave action prior to dissolution.

In other embodiments, the surface spreading agent may be delivered in solution and, thus, the film-forming composition may include one or more solvents that are used to dissolve the surface spreading agent(s) into solution. In this embodiment, the film-forming composition may be free of the dispersing agent and densifying agent, as described above. Examples of suitable solvents include, but are not limited to, polyethylene glycol, tetrahydrofuran or tetrahydrofurfuryl alcohol, and water-soluble saccharides. Film-forming compositions that include polydiorganosiloxane as the surface spreading agent may include canola oil, and canola oil may also be employed to dissolve or mix polyoxyethylene ether into solution. Additionally, alkanes (such as octadecane) may also be employed as solvents.

As additional functional components that may be present in the film-forming composition independent of whether the film-forming composition is in liquid or solid form, a conventional biocide and/or algaecide may be present to further inhibit propagation of biological species in the open-air pond.

In another embodiment, a surface protectant agent having a specific gravity lower than that of the surface spreading agent is incorporated into the film-forming composition or added to the water holding pond 12 separate from the film-forming composition. With the surface protectant agent having a lower specific gravity than the surface spreading agent, it is believed that the surface protectant agent will form a surface protectant layer 32 over the surface spreading layer 14 with the surface protectant layer 32 and the surface spreading layer 14 forming a stratified layer configuration on the surface of the water storage pond 12 as shown in FIG. 3. In this regard, the surface protectant layer 32 may further impede mass transfer mechanisms occurring at the interface between the water holding pond 12 and the atmosphere. In embodiments, suitable surface protectant agents include alkanes containing from 10 to 24 carbon atoms.

In embodiments, the film-forming composition is formulated with both the densifying agent and the surface protectant agent, and the film forming composition having both a liquid phase and a solid phase. In this embodiment, the densifying agent may assist with sub-surface delivery of the surface spreading agent while the surface protectant agent remains at or near the surface of the water during delivery. As such, this delivery mechanism may promote formation of the stratified layer configuration.

Referring again to FIG. 2, the oilfield water storage system 10 may further include additional features to assist with management thereof. For example, in embodiments, the oilfield water storage system 10 further includes a controller 34 configured to add the surface spreading agent or film-forming composition upon detecting a pre-determined trigger event. Additionally, in embodiments, the oilfield water storage system 10 further includes a detector 36 that is configured to provide a signal corresponding to the pre-determined trigger event. For example, in embodiments, the detector 36 is a mechanism, such as a sensor, having functionality to detect presence of (and optionally amount of) bacterial species and/or presence of chemical species such as the surface spreading agent and/or the surface protectant agent. For example, the pre-determined trigger event can be based on the signal from the detector 36 indicating that a content of biological species is present above an acceptable level. In another embodiment, the pre-determined trigger event is based on the signal from the detector 36 indicating a deficiency of the surface spreading agent. For example, the controller 34 may be in operable communication with a dispersing module 38 that contains the surface spreading agent or film-forming composition to increase an amount thereof in the water holding pond 12 as needed. Additionally, when the mechanical agitator 22 is employed, the controller may appropriately initiate or modify venting conditions for the open-air pond using the mechanical agitator 22. The mechanical agitator 22 may additionally be situated proximate to the dispersing module 38 to assist with sub-surface dispersal of the surface spreading agent or film-forming composition.

Instead of or in addition to employing the detector 36 to monitor the surface spreading layer 14, an alternative method for identifying the presence of surface spreading agent in an open-air water holding pond 12 may be employed. Over time, the surface spreading layer 14 can degrade and eventually dissipate, at which time more of the surface spreading agent is to be added to the water holding pond 12. Since environmental conditions can differ from one geographic location to the next, the rate of degradation varies. Furthermore, since the surface spreading layer 14 is by nature very thin, it may not be possible to visibly detect the presence of the surface spreading layer on the surface of the water holding pond 12. In an embodiment, to detect the presence of the surface spreading layer 14 independent of use of the detector 36, a buoyant, water soluble indicator is applied to the surface of the water holding pond 12. Provided that the surface spreading layer 14 is present on the surface of the water holding pond 12, the dissolution of the water soluble material is impeded. In this way, the surface spreading layer 14 can be detected by observing whether the water soluble material dissolves or not after application to the surface of the water holding pond 12. In embodiments, the buoyant, water soluble indicator is applied to the surface of the water holding pond 12 a period of time after application of the surface spreading agent to the water holding pond 12. For example, in an embodiment, the buoyant, water soluble indicator is applied to the surface of the water holding pond 12 at least 30 minutes after applying the film-forming composition to provide sufficient time for the surface spreading layer 14 to self-assemble and disperse across the water holding pond 12. In this regard, the buoyant, water soluble indicator may be employed to determine whether the dosage of the surface spreading agent in the water holding pond 12 is sufficient. Additional surface spreading agent can then be applied to the water holding pond 12 if deemed necessary. In other embodiments, the buoyant, water soluble indicator is applied to the surface of the water holding pond 12 at least one day after applying the film-forming composition to determine if the surface spreading layer 14 is still effectively present on the surface of the water holding pond 12. Additional surface spreading agent can then be applied to the water holding pond 12 if deemed necessary.

Materials that can be used as the water soluble indicator include, for example, powdered hydrated lime, powdered lactic acid, powdered polyvinyl alcohol, and a polyvinyl alcohol sheet. For scenarios where the water soluble indicator is in powdered form, the surface area of the powder may be selected such that the powder is buoyant and tends to the surface of the water. For scenarios where the water soluble indicator is in sheet form, the thickness of the sheet may be controlled such that the sheet is buoyant and tends to the surface of the water.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. An oilfield water storage system comprising a water storage pond, a surface spreading layer comprising a surface spreading agent and disposed on a surface of the water storage pond, and a water outlet pipe in fluid communication with the water storage pond below the surface treatment layer.

2. The oilfield water storage system of claim 1, wherein the water storage pond is an open-air water storage pond.

3. The oilfield water storage system of claim 1, wherein the surface spreading agent is chosen from an aliphatic alcohol having from 12 to 24 carbon atoms; polydiorganosiloxanes; polyoxyethylene ether; or a combination thereof.

4. The oilfield water storage system of claim 1, further comprising a mechanical agitator adapted to agitate the surface of the water in the water storage pond.

5. The oilfield water storage system of claim 4, further comprising a barrier forming an at least semi-enclosed barrier area in the water storage pond, with the mechanical agitator positioned therein.

6. The oilfield water storage system of claim 1, further comprising a dispersing agent entrained in the surface spreading layer.

7. The oilfield water storage system of claim 1, further comprising a densifying agent entrained in the surface spreading layer.

8. The oilfield water storage system of claim 1, further comprising a surface protectant layer comprising a surface protectant agent having a lower specific gravity than the surface spreading agent, wherein the surface protectant layer is disposed over the surface spreading layer and wherein the surface protectant layer and the surface spreading layer form a stratified layer configuration on the surface of the water storage pond.

9. The oilfield water storage system of claim 1, further comprising a controller and a dispersing module, wherein the controller is configured to add the surface spreading agent from the surface spreading module upon detecting a pre-determined trigger event.

10. The oilfield water storage system of claim 9, further comprising a detector, and wherein the detector is configured to provide a signal corresponding to the pre-determined trigger event.

11. The oilfield water storage system of claim 9, further comprising a barrier forming an at least semi-enclosed barrier area in the water storage pond, with the mechanical agitator positioned therein and with the mechanical agitator positioned proximate to the dispersing module to assist with sub-surface dispersal of the surface spreading agent provided therefrom.

12. The oilfield water storage system of claim 1, wherein surface spreading layer is a monomolecular layer.

13. The oilfield water storage system of claim 1, further comprising a hydraulic fracturing pump adapted to receive and pressurize water from the water outlet pipe for delivery to a well head and down into a well.

14. A method of managing an oilfield water storage system, wherein the method comprises:
applying a film-forming composition comprising a surface spreading agent to a water holding pond of the oilfield water storage system.

15. The method of claim 14, wherein applying a film-forming composition comprises applying the film-forming composition further comprising a dissolution agent and a densifying agent, wherein the densifying agent has a density greater than water and also greater than the surface spreading agent to provide the film-forming composition with a density greater than water.

16. The method of claim 15, wherein the film-forming composition is in a solid form chosen from granules or pellets, and wherein the film-forming composition is applied to release at least a portion of the surface spreading agent from beneath a surface of the water in the water holding pond.

17. The method of claim 16, further comprising adding a surface protectant agent to the water holding pond, wherein the surface protectant agent has a specific gravity lower than that of the surface spreading agent and wherein the surface protectant agent forms a surface protectant layer over the surface spreading layer in the water storage pond.

18. The method of claim 14, further comprising applying a buoyant, water soluble indicator different from the film-forming composition to a surface of the water after applying the film-forming composition to the water holding pond.

19. The method of claim 18, wherein the buoyant, water soluble indicator is applied at least 30 minutes after applying the film-forming composition to the water holding pond.

20. A film-forming composition adapted for application to a water holding pond, wherein the film-forming composition comprises:
a surface spreading agent present in an amount of at least 1 weight %, based on the total weight of the film-forming composition;
a densifying agent having a higher density than water and the surface spreading agent; and
a dissolution agent;
wherein the film-forming composition has a higher density than water.
